(19) United States
(12) Patent Application Publication
(10) Pub. No.: US 2020/0108661 A1
(43) Pub. Date: Apr. 9, 2020

(54) Rear Axel for Small Vehicles

(71) Applicant: Ronald A. Holland, Carlsbad, CA (US)

(72) Inventor: Ronald A. Holland, Carlsbad, CA (US)

(21) Appl. No.: 16/590,350

(22) Filed: Oct. 1, 2019

Related U.S. Application Data
(60) Provisional application No. 62/741,109, filed on Oct. 4, 2018.

(51) Int. Cl. B60B 35/18; B60K 17/00; B60B 35/14; F16C 35/04

(52) U.S. Cl. CPC B60B 35/18; B60K 17/00; B60B 35/14; F16C 2326/01; B60B 2900/112; B60B 2900/541; F16C 35/047

(57) ABSTRACT

A rear axle system keeps rear wheels turning on the same axis when they are fixedly attached to the axles. One embodiment of the present invention fixedly attaches an axle to each rear wheel. Each of the axles extend through a self aligning, pillow block bearing to almost the center of the vehicle. The bearings are mounted to the outer portion of the frame on each side and there is a tube that encases the two axles. The inner diameter of the tube is large enough to allow the two axles to turn with respect to each other but small enough to keep the two axles turning on the same axis. When the vehicle is traveling in a straight line, the tube is turning with the axles. When the vehicle is turning, there is little difference in speed and no requirement for bearings between the axles and the rigid tube.

### CROSS-REFERENCE TO RELATED APPLICATIONS

The present application claims the priority of U.S. Provisional Patent Application Ser. No. 62/741,109 filed Oct. 4, 2018 which application is incorporated in its entirety herein by reference.

### BACKGROUND OF THE INVENTION

The present invention relates in general to small, inexpensive vehicles with two rear wheels at least one of which is a drive wheel, and more particularly to a new, simple, and inexpensive method of keeping the rear wheels turning on the same axis.

While driving on a curved path one of the rear wheels of a vehicle with two rear wheels must turn faster than the other without skidding one or both of the rear tires. Therefore if the axles are fixedly attached to the wheels then the axles must be able to turn independent of each other, hence, the need for a differential. When the bearings supporting the rear axles, without a differential, are fixedly mounted to the frame of the vehicle there is at least the following disadvantage. Each wheel requires two bearings to support and align it properly which is costly, difficult to align, and difficult to maintain the alignment.

### BRIEF SUMMARY OF THE INVENTION

The present invention addresses the above and other disadvantages by providing a rear axle system keeping the rear wheels turning on the same axis when they are fixedly attached to the axles. One embodiment of the rear axle system fixedly attaches an axle to each rear wheel. Each of the axles extend through a self aligning, pillow block bearing to almost the center of the vehicle. The bearings are mounted to the outer portion of the frame on each side and there is a tube that encases the two axles almost up to each of the bearings. The inner diameter of the tube is large enough to allow the two axles to turn with respect to each other but small enough to keep the two axles turning on the same axis. When the vehicle is traveling in a straight line, the tube is turning with the axles and when the vehicle is turning either right or left at its highest speed, there is very little difference in the speed of the axles, therefore there would be no requirement for bearings between the axles and the tube.

In accordance with one aspect of the invention, there is provided a rear axle system including driven sprockets fixedly attached to axles close to bearings on the inside of a vehicle frame which allows the whole chain drive to be on the inside of the frame for protection. This arrangement also reduces the number of bearings required and the need for attaching the driven sprocket to the wheel, which reduces the cost of a small inexpensive vehicle with “rear wheel drive”.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a diagrammatic partial end view of the rear end of a vehicle with the preferred embodiment of the present invention installed.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement.

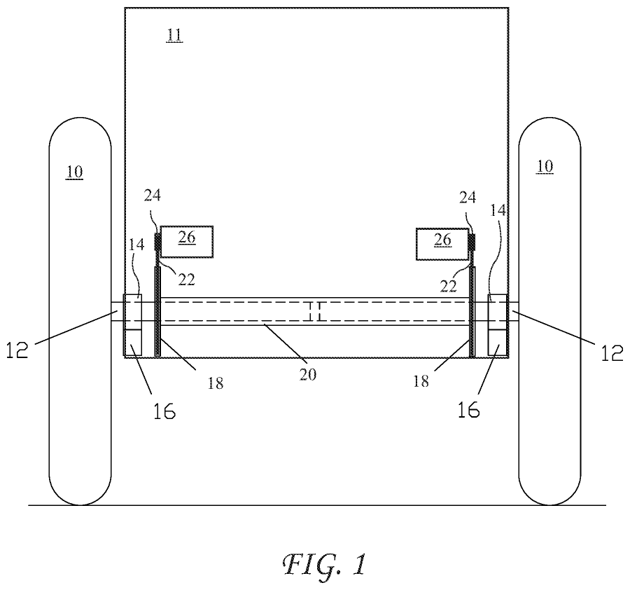

Referring to FIG. 1, wheels 10 are fixedly attached to the axles 12 which extend through the self aligning pillow block bearings 14 to about the center of a vehicle 11. The bearings 14 are fixedly attached to a frame 16 the vehicle 11. The driven sprockets or pulleys 18 are fixedly attached to the axles 12 which allows each wheel 10 to be driven by separate power sources 26 through chains or belts 22. The tube 20 encloses the axles 12 up to the sprockets or pulleys 18 on each side of the vehicle 11 which keeps the axles 12 aligned but allows them to turn independently.

There is preferably about a 0.010 inch clearance between the axles and the rigid tube. A preferred rigid tube is 1.25″ outside diameter, 0.120 wall, Drawn Over Mandrel (DOM) tubing. A heavy grease or preferable a dry lubricant (for example graphite) may be used between the axles and rigid tube as a lubricant.

While the invention herein disclosed has been described by means of specific embodiments and applications thereof, numerous modifications and variations could be made thereto by those skilled in the art without departing from the scope of the invention set forth in the claims.

I claim:

1. A vehicle rear axle system, comprising:
a vehicle frame supporting a vehicle;
right and left pillow bearings attached to right and left sides of the vehicle frame;
a rigid tube residing between the right and left pillow bearings;
right and left axles held by the right and left pillow bearings respectively, inner ends of the right and left axles incasing the rigid tube, the right and left axles independently rotatable with respect to the rigid tube;
at least one power source driving either the right and left axle; and
right and left wheels attached to right and left ends of the right and left axles respectively.

2. The vehicle rear axle system of claim 1, wherein:
a sprocket or pulley is attached to the right or left axle between the right or left pillow bearing and right or left end of the rigid tube; and
the power source connected to the right or left axle through the sprocket or pulley.

3. The vehicle rear axle system of claim 1, wherein the at least one power sources comprises right and a left power sources driving the right and left axles respectively.

4. The vehicle rear axle system of claim 3, wherein:
sprockets or pulleys are attached to the right and left axle between the right and left pillow bearings and right and left ends of the rigid tube; and
the power sources drive the right and left axles through chains or belts and the sprockets or pulleys.

5. The vehicle rear axle system of Claim, wherein the right and left axles reach into the rigid tube to the center of the rigid tube, but do not touch.

6. A vehicle rear axle system, comprising:
a vehicle frame supporting a vehicle;
right and left pillow bearings attached to right and left sides of the vehicle frame;
a rigid tube residing between the right and left pillow bearings;
right and left axles held by the right and left pillow bearings respectively;
inner ends of the right and left axles encased in the rigid tube reaching to the center of the rigid tube;
the right axle independently rotatable with respect to the left axle;
the right and left axles independently rotatable with respect to the rigid tube;
right and left sprockets or pulleys are attached to the right and left axle between the right and left pillow bearings and right and left ends of the rigid tube;
right and left power sources driving the right and left axles through the right and left sprockets or pulleys; and
right and left wheel attached to right and left ends of the right and left axles respectively.

7. A vehicle rear axle system, comprising:
a vehicle frame supporting a vehicle;
right and left pillow bearings attached to right and left sides of the vehicle frame;
a rigid tube residing between the right and left pillow bearings;
right and left axles held by the right and left pillow bearings respectively;
inner ends of the right and left axles encased in the rigid tube reaching to the center of the rigid tube but not touching and independently rotatable with respect to the rigid tube;
the right axle independently rotatable with respect to the left axle;
right and left sprockets or pulleys are attached to the right and left axle between the right and left pillow bearings and right and left ends of the rigid tube;
right and left power sources driving the right and left axles through the right and left sprockets or pulleys; and
right and left wheel attached to right and left ends of the right and left axles respectively.
